(19) United States
(12) Patent Application Publication
(10) Pub. No.: US 2013/0160095 A1
(43) Pub. Date: Jun. 20, 2013

(54) METHOD AND APPARATUS FOR PRESENTING A CHALLENGE RESPONSE INPUT MECHANISM

(71) Applicant: Alexandr SELEZNYOV, Espoo (FI)

(72) Inventor: Alexandr SELEZNYOV, Espoo (FI)

(73) Assignee: NOKIA CORPORATION, Espoo (FI)

(21) Appl. No.: 13/325,609

(22) Filed: Dec. 14, 2011

(51) Int. Cl. G06F 21/00

(52) U.S. Cl. 726/5

(57) ABSTRACT

An approach is provided for presenting a challenge response input mechanism on a device. A user receives a challenge (e.g., a CAPTCHA, a password prompt, a login prompt, etc.) when attempting to access a service and/or a resource wherein the user has to provide a response before access to the service or to the resource is granted. Further, one or more applications on the user device and/or at a service provider present a combination dial/slider on the user device whereby the user may interface with the input mechanism for constructing a response to the challenge.

### BACKGROUND

Modern computer and communication networks provide access to an ever increasing variety and number of online services (e.g., databases, services, commerce, etc.) to users and user devices. Many of these online services deal with potentially sensitive or private information (e.g., personal information, financial information, etc.). As a result, services providers have traditionally employed various security measures in order to protect users' information as well as their network resources, databases, and the like, and to provide a certain quality of service and trust over their networks. Traditionally, authentication mechanisms include requiring users to have/create user accounts and submit user information (e.g., a password) for access to the user account and services. Once authenticated, users or their devices may be authorized to access information, networks, databases, and other resources. Further, some services utilize a challenge/response process (e.g., a CAPTCHA process) to verify that a user is human and not automated computer programs or robots (bots). However, inputting responses to these challenge processes can be difficult or cumbersome particularly on devices with limited input and/or display resources (e.g., mobile devices). As a result, service providers and device manufacturers face significant technical challenges to developing security measures (e.g., challenge/response processes) that provide for more means to more easily input challenge responses.

### SOME EXAMPLE EMBODIMENTS

Therefore, there is a need for a robust and user-friendly method for presenting a challenge response input mechanism.

According to one embodiment, a method comprises determining a prompt for a challenge on a device. The method also comprises causing, at least in part, a rendering of an input mechanism for responding to the challenge, wherein the input mechanism presents, at least in part, one or more characters, one or more symbols, or a combination thereof for constructing a response to the challenge.

According to another embodiment, an apparatus comprising at least one processor, and at least one memory including computer program code, the at least one memory and the computer program code configured to, with the at least one processor, cause, at least in part, the apparatus to determine a prompt for a challenge on a device. The apparatus is also caused to cause, at least in part, a rendering of an input mechanism for responding to the challenge, wherein the input mechanism presents, at least in part, one or more characters, one or more symbols, or a combination thereof for constructing a response to the challenge.

According to another embodiment, a computer-readable storage medium carrying one or more sequences of one or more instructions which, when executed by one or more processors, cause, at least in part, an apparatus to determine a prompt for a challenge on a device. The apparatus is also caused to cause, at least in part, a rendering of an input mechanism for responding to the challenge, wherein the input mechanism presents, at least in part, one or more characters, one or more symbols, or a combination thereof for constructing a response to the challenge.

According to another embodiment, an apparatus comprises means for determining a prompt for a challenge on a device. The apparatus further comprises means for causing, at least in part, a rendering of an input mechanism for responding to the challenge, wherein the input mechanism presents, at least in part, one or more characters, one or more symbols, or a combination thereof for constructing a response to the challenge.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of presenting a challenge response input mechanism, according to one embodiment

FIG. 2 is a diagram of the components of a user equipment capable of receiving a challenge and rendering an input mechanism, according to one embodiment

FIG. 3 is a flowchart of a process for determining a prompt for a challenge and rendering an input mechanism for responding to the challenge, according to one embodiment

FIG. 4 is a flowchart of a process for rendering an input mechanism and one or more characters associated with a challenge, according to one embodiment;

FIGS. 5A and 5B are diagrams of user interfaces depicting challenges and input mechanisms, according to various embodiments;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for presenting a challenge response input mechanism on a device are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

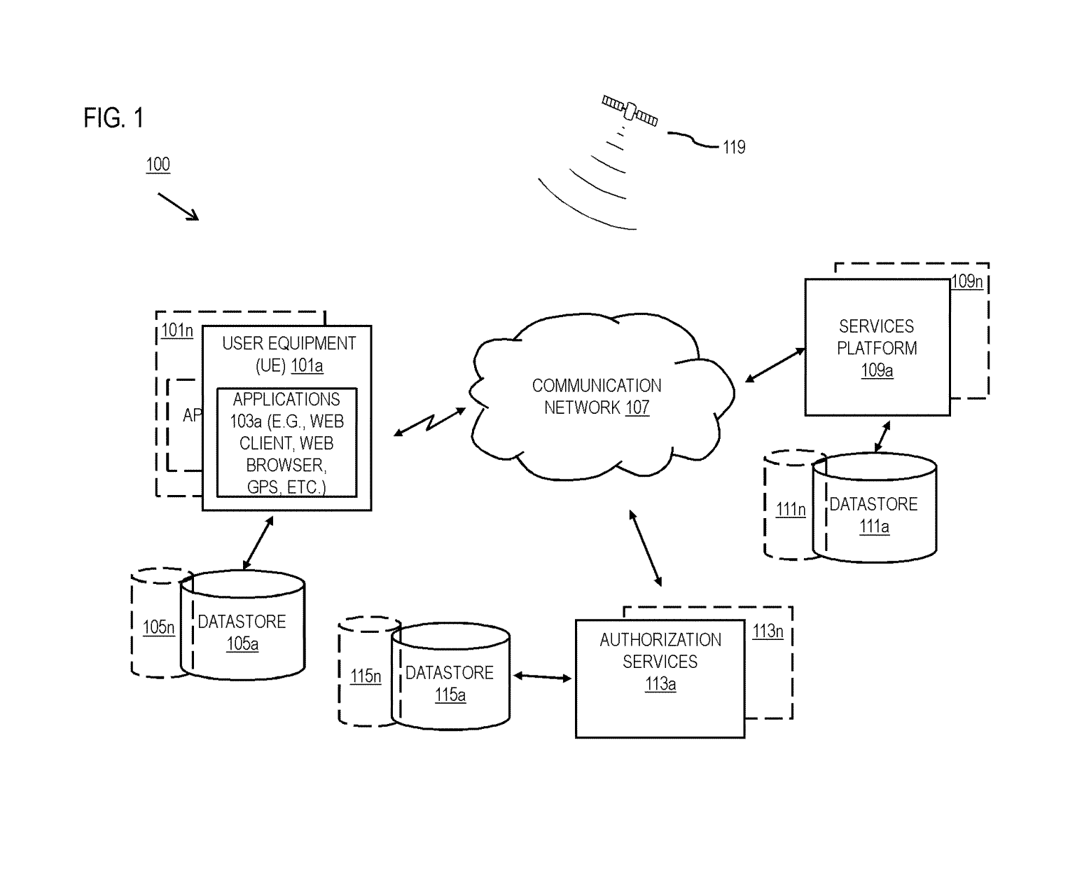

FIG. 1 is a diagram of a system capable of presenting a challenge response input mechanism on a device, according to one embodiment. As discussed above, a broad range of services, transactions, commerce, etc. are provided and/or are conducted over the internet. By way of example, these online services include financial services, sale of merchandise and services, online trading, social networking, email, access to one or more databases, etc. Because these services are often targets of a growing number of attacks, security risks to the merchants, service providers and users of these online services have been steadily rising. To combat such risks as online fraud, identity theft, attacks on networks, unauthorized account and database access, the network administrators have often implemented security measures including requiring user registration, user password and/or other identifying parameters.

In one common scenario, automated software programs, or “bots,” can pose security risks and/or otherwise cause problems for many online services. For example, bats can be used to automatically sign up for email addresses from online email services (e.g., so that the addresses can be used for spam or other fraudulent purposes), or to automatically purchase large blocks of tickets for concerts or shows (e.g., so that tickets can be resold at higher prices). According to one conventional approach, to distinguish software bots from actual human users, many services rely on CAPTCHA (Completely Automated Public Turing test to tell Computers and Humans Apart) challenges. Generally, a CAPTCHA process is a challenge-response based test, which is utilized to assess whether a response to a challenge is likely generated by a human. For example, a challenge may comprise one or more distorted target images; for example, a string of characters, images, text, numerals, audio and/or video; which would be difficult for software bots to recognize and identify correctly. Generally, the distortion is achieved by blurring, overlapping, stacking, striking through by one or more lines, varying one or more geometrical characteristics of the target image, and the like. Further, a correct response to the challenge would indicate, with high level of certainty that the response is by a human. In other words, humans typically can, for example, recognize a distorted image while many computer programs cannot, thereby providing a means to differentiate a software bot from a human before granting service and/or access authorization.

However, as different users utilize different devices with different or limited user interfaces and input mechanisms, it may be difficult for the users to successfully and correctly input a response to the challenge. For example, various user devices have various user interface and input mechanisms such as color display, monotone display, gray-scale display, physical keypad, virtual keypad, numeric keypad, alphanumeric keypad, touch screen display and the like. Further, it can be difficult for a service provider to successfully implement a CAPTCHA process when considering various parameters such as different user languages, different devices and different regions associated with a user. Furthermore, similar issues may exist in an authentication system requiring one or more user information items (e.g., name, account number, password, etc.) where the user is required to timely and accurately input the required information items. For example, a CAPTCHA presenting a color scheme to a user and requesting for the user to identify the colors presented in the color scheme would not work on a user device which cannot display colors (e.g., a monochrome display). In another example, a CAPTCHA may cause a virtual keypad to be displayed on a user device display which may cause a moving and/or covering of all or portions of the CAPTCHA thereby making it difficult or impossible for the user to see the CAPTCHA. In another example where a device has a numeric (physical or virtual) keypad, it would be very difficult for a user to timely and accurately enter alphanumeric characters. In another example, global service providers would need to consider and support different regional requirements (e.g., languages, alphabet, literacy level, etc.) when implementing/utilizing CAPTCHA and/or authentication processes which would be very difficult to implement.

To address these problems, system 100 of FIG. 1 is capable of presenting a challenge response input mechanism on a device whereby a user can utilize the input mechanisms to timely and accurately construct a response for one or more verification and/or authentication challenges. Although various embodiments are discussed with respect to providing an input mechanism for responding to challenges such as CAPTCHA challenges, it is contemplated that the various embodiments are applicable to inputting information in general (e.g., text, symbols, parameters, etc.).

In one embodiment, the system 100 generates one or more challenges (e.g., for a CAPTCHA, for a password, etc.) incorporating one or more characteristics (e.g., phrase, image, text, numeral, audio, video, password prompt, etc.) and presents the one or more challenges to a user of a user device wherein the user may generate and submit one or more responses via the user device.

In one embodiment, a service provider and/or an authorization/verification service generates a challenge, which may be in response to a service request (e.g., for accessing a database) from the user and/or a user device. Further, the challenge causes a determination and presentation of a prompt on a device. In various embodiments, the challenge may be for a CAPTCHA process, an authentication process and the like. For example, the challenge may comprise one or more distorted images of text characters, of objects, audio, video, etc., wherein the user has to identify, match, name, select, etc. the one or more images presented in the challenge. In another example, the challenge may be a prompt for the user to enter/submit one or more user information such as login name, account number, password and the like.

In various embodiments, the challenge and/or the user device cause, at least in part, a rendering of an input mechanism for responding to the challenge, wherein the input mechanism presents, at least in part, one or more characters, one or more symbols, or a combination thereof for constructing a response to the challenge. For example, the challenge may include various distorted images (e.g., of text, pictures, etc.) where the user has to recognize each image and select/present a corresponding image via an input mechanism on the user device. In one example, the user may utilize one or more virtual tumbler/combination dials/sliders to select one or more characters corresponding to the one or more characters presented in the challenge. In various embodiments, a user utilizes the virtual combination dials/sliders input mechanism to select, construct and present one or more characters for a password, a login name, an account number and the like.

In another embodiment, the input mechanism may be rendered based, at least in part, on one or more CAPTCHA parameters. For example, the CAPTCHA generator (e.g., a service provider, an authorization services, etc.) may provide information on the number of characters (e.g., five different Latin letters) present in a given challenge wherein the information may be utilized by one or more applications on the user device and/or a service provider to determine possible number of characters necessary to have on the input mechanism (e.g., 10, 15, 20, etc.) so that a user may be able to utilize the input mechanism for inputting a proper response. In another example, a CAPTCHA may comprise a combination of alphanumeric and geometrical characters wherein the input mechanism is determined such that it includes the alphanumeric and geometrical figures required for constructing a proper response. It is noted that the ability to render a virtual input mechanism based, at least in part, on a given CAPTCHA provides for a dynamic and flexible input mechanism such that it can comprise multiple possible combination of characters, letters, numbers, languages, figures and the like as utilized in generating a CAPTCHA.

In one embodiment, a service provider and/or a user device determine the input mechanism based, at least in part, on device capability. For example, a service provider may request, receive and utilize the device capability information when generating and/or presenting a challenge at the user device. In various embodiments, determining interaction information with the input mechanism based, at least in part, on touch input, a keyboard input, a virtual scroller, a joystick input, an audio input, a video input, or a combination thereof. For example, the capability information may indicate that the user device has certain user interface/input capabilities such as a physical keypad, a virtual scroller, a joystick, a color display, touch sensitive display, certain size of a display, a certain type of keypad, an audio input, a video input and the like. In an example, user device capability information indicates availability of a touch sensitive display whereby a combination dial can be presented to the user and which can be utilized by the user to construct a response to a challenge. In another example, a user device may utilize a keypad (e.g., physical or virtual) to interface with the one or more combination dials to select one or more characters (e.g., figures) for constructing and/or submitting a response to a challenge.

In another embodiment, an input mechanism, the one or more characters, the one or more symbols, or a combination thereof are presented in a form of one or more combination dials. For example, a CAPTCHA challenge may include an image comprising multiple characters (e.g., geometrical shapes) which may be distorted and/or blurred. Further, one or more tumbler/combination dials are presented to the user whereby the user can select characters (e.g., via a touch screen, via a virtual scroller, via a keypad, via a joystick, etc.) on the tumbler/combination dials corresponding to the characters presented in the challenge.

In various embodiments, the challenge, the input mechanism, the one or more characters, the one or more symbols, or a combination thereof are received from a remote service. For example, a user may request for a service from a service provider, wherein the service provider may require authorization/verification of the user before providing the requested service. Further, the service provider and/or an authorization/verification service may utilize one or more characters and/or one or more symbols to generate and present a challenge and an input mechanism to the user for the authorization/verification. In another embodiment, the input mechanism is a web object. For example the input mechanism is substantially generated by a service provider and presented as a web object (e.g., Java application) wherein the user device does not need to have a special application for rendering the input mechanism and can run in a web browser application.

In another embodiment, the challenge, the one or more characters and/or the one or more symbols are received as at least one image. For example, an image comprises one or more altered/distorted characters (e.g., textual, geometric, etc.) and instructions (e.g., a challenge) for a user to identify and/or match the altered/distorted characters to another set of characters via an input mechanism.

In one embodiment, at least a portion of the at least one image is presented in the input mechanism. For example, (1) a challenge image has multiple characters therein (e.g., textual), (2) a combination dial (e.g., with multiple dials) is utilized and presented as an input mechanism, and (3) at least one character is presented on the combination dial.

In one embodiment, the user determines an input for selecting the at least a portion of the at least one image. For example, the user may choose (e.g., highlight, select, etc.) a character from a multiple of characters presented in a challenge image so that the user can determine and select a corresponding character on the input mechanism.

In one embodiment, one or more inputs are processed (e.g., by one or more applications on the user device) in order to determine an associated at least one of the one or more characters, the one or more symbols for constructing a response. In one use scenario, there are four distorted alphabet characters in the challenge image wherein the user selects the first character (e.g., by clicking on a character via the device UI) and then utilizes an input mechanism (e.g., a combination dial on a touch screen) to select a corresponding character for constructing a response to the challenge.

In one embodiment, a language for the challenge, the one or more characters, the one or more symbols, or a combination thereof is selected (e.g., by a service provider) independently of another language that is associated with the device, a user of the device, or a combination thereof. For example, a service provider may utilize one or more languages for generating a challenge wherein the languages may be different than one or more languages defined/selected by a user who will be receiving the one or more challenges. In one use case, an image in a challenge includes three distorted Latin characters (e.g., [symbol] , [symbol] , [symbol] ) wherein a combination dial comprises at least a portion of the Latin alphabet that includes the three Latin characters (e.g., K, D, O) presented in the challenge image.

As shown in FIG. 1, the system 100 comprises one or more user equipment (UE) 101a-101n (also collectively referred to as UE 101 and/or user device) having connectivity to one or more services platform 109a-109n (also collectively referred to as services platform 109) and one or more authorization services 113-a-113n (also collectively referred to as authorization services 113) via a communication network 107. The UEs 101a-101n include applications 103a-103n (also collectively referred to as applications 103) where applications 103 can include, for instance, one or more user interfaces, one or more communications applications, one or more web browsers, one or more web clients, and/or other applications to support sensors such as GPS, audio/video devices and/or the like available on the UE 101.

Further, the services platform 109 can provide a broad range of online services; such as commerce, financial services, database access, social networking, education, internet access; and/or the like. In the example of FIG. 1, the UE 101, services platform 109, and authorization services 113 include one or more data sets in their respective datastores 105a-105n (also collectively referred to as datastore 105), 111a-111n (also collectively referred to as datastore 111) and 115a-115n (also collectively referred to as datastore 115). Data maintained by the UE 101, services platform 109, and authorization services 113 can be that of a static nature (e.g., textual data, graphical data) or executable (e.g., streaming media such as audio or video content).

Moreover, the services platform 109 and authorization services 113 may be a hosted server platform, data warehouse, service portal, web server with associated service interface or the like for enabling access to the services at the services platform 109 and/or other available resources. Depending on system requirements, the datastores 111 and 115 may be distributed wherein data sets are dispersed. Alternatively, services platform 109 and authorization services 113 may communicate with one another for enabling data exchange, therefore facilitating further distributed processing capability. Such an arrangement may be useful for maintaining very large data sets and providing a wider range of service.

In addition to the services platform 109 and authorization services 113, the UE 101 may also have connectivity via the communication network 107 to other UEs (e.g., another mobile device). While shown identically in the figure, respective UEs 101a and 101n need not be implemented identically. In one embodiment, the services platform 109 and authorization services 113 and their respective datastores 111 and 115 may be combined into one or more network elements in one or more configurations to provide substantially same functionality and/or services. In certain embodiments, the UE 101 may utilize GPS satellites 119 to determine location of the UE 101 for receiving location based services and/or to provide to one or more service providers for their utilization, for example, in determining an appropriate CAPTCHA for the user.

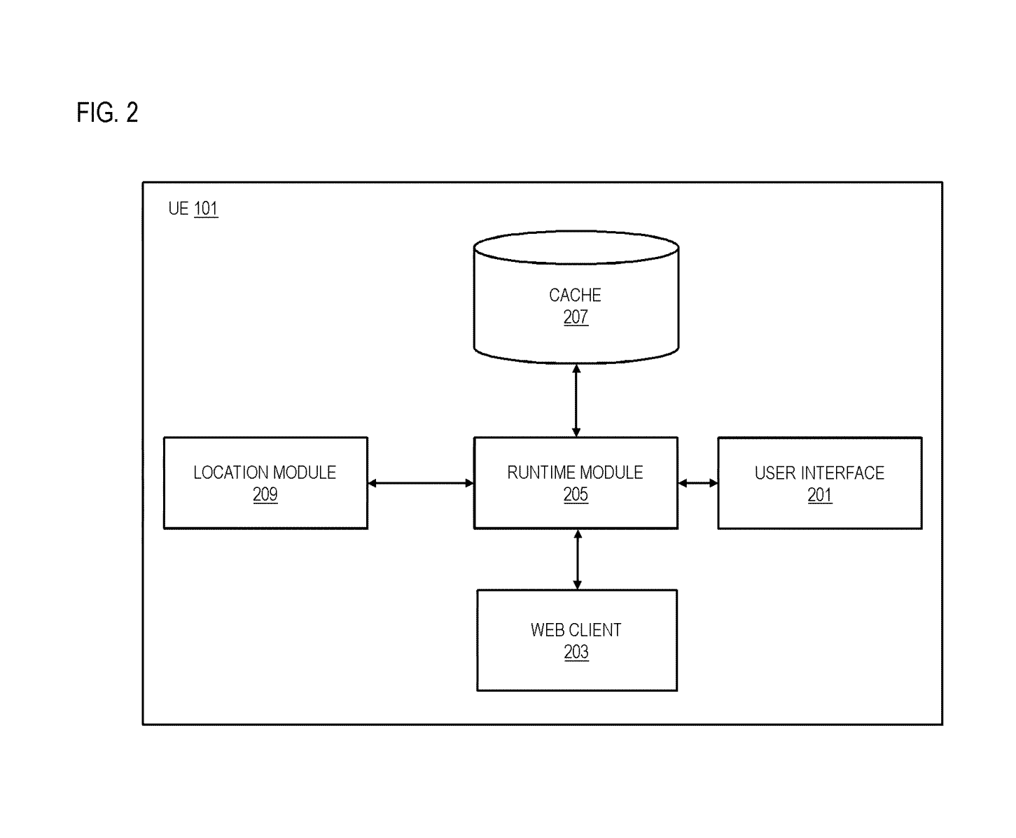

FIG. 2 is a diagram of the components of a user equipment capable of receiving a challenge and presenting a response input mechanism, according to one embodiment. By way of example, the UE 101 includes one or more components for receiving a challenge and constructing and submitting a response as discussed in various embodiments of the approach described herein. It is contemplated that the functions of these components may be combined in one or more components or performed by other components of equivalent functionality. In this embodiment, the UE 101 includes a user interface UI 201 to present a challenge to a user, one or more input mechanisms for constructing a response to the challenge, and to submit the response. A web client 203 to receive a challenge and present one or more input mechanisms for constructing and submitting a response; a runtime module 205 for executing one or more applications 103 (e.g., UI, touch screen, virtual keypad, combination dial, etc.), navigation application, web client application, etc.); a cache 207 to locally store one or more user and/or user device parameters and a location module 209 to determine a location of the UE 101 wherein the user location information can be retrieved and utilized by a service provider in generating one or more challenges for the user. Further, the user may interface with the one or more input mechanisms via the UI 201, which may include various methods of communication. For example, the UI 201 can have outputs including a visual component (e.g., a screen), an audio component (e.g., a verbal instructions), a physical component (e.g., haptic feedback), and other methods of communication. User inputs can include a touch-screen interface, microphone, camera, a scroll-and-click interface, a button interface, etc. Further, the user may receive a challenge via applications 103 (e.g., a web client) and utilize the UI 201 to interface with one or more input mechanisms for constructing and submitting a response to the challenge.

In one embodiment, the location module 209 can determine a user's location. The user's location can be determined by a triangulation system such as a GPS, assisted GPS (A-GPS) A-GPS, Cell of Origin, wireless local area network triangulation, or other location extrapolation technologies. Standard GPS and A-GPS systems can use satellites 119 to pinpoint the location (e.g., longitude, latitude, and altitude) of the UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 209 may also utilize multiple technologies to detect the location of the UE 101. GPS coordinates can provide finer detail as to the location of the UE 101. As previously noted, the location module 209 may be utilized to determine location coordinates for use by the applications 103 and/or by one or more service providers.

The UE 101, services platform 109 and authorization services 113 can communicate with each other, other network elements and/or access other data stores by communicating, for example, over the communication network 107. By way of example, the communication network 107 of system 100 includes one or more networks such as a data network (not shown), a wireless network (not shown), a telephony network (not shown) or any combination thereof It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof It is also contemplated that the UE 101 can support any type of interface to the user (such as “wearable” circuitry, etc.).

By way of example, the UE 101, the services platform 109, and the authorization services 113 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

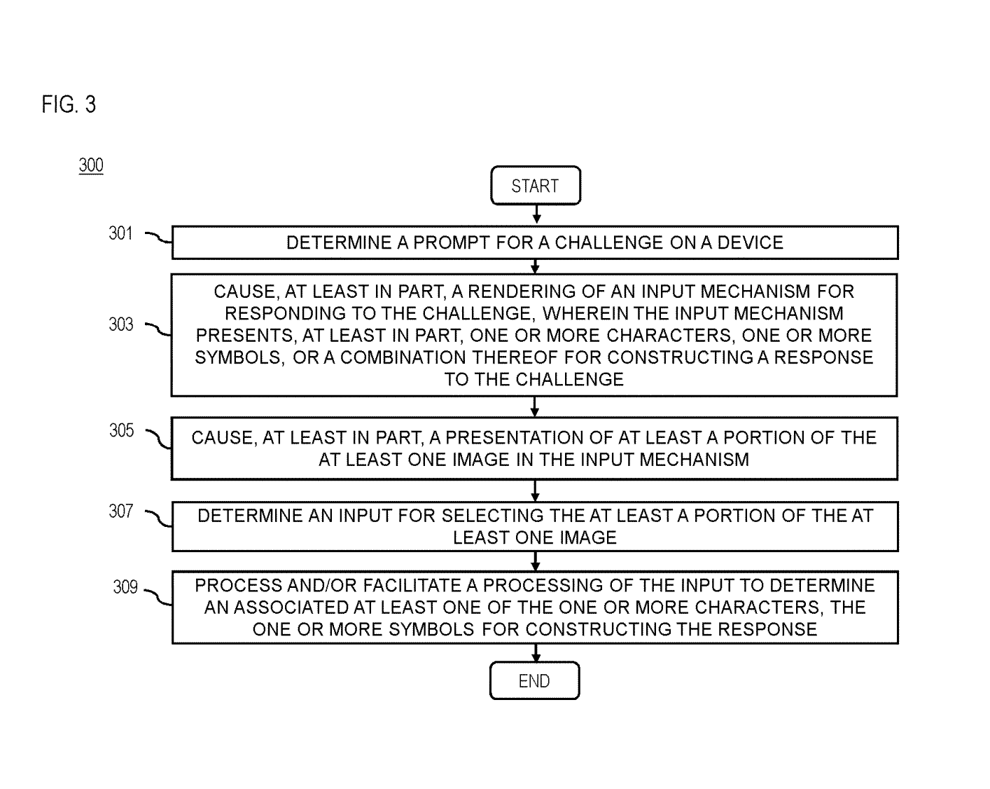

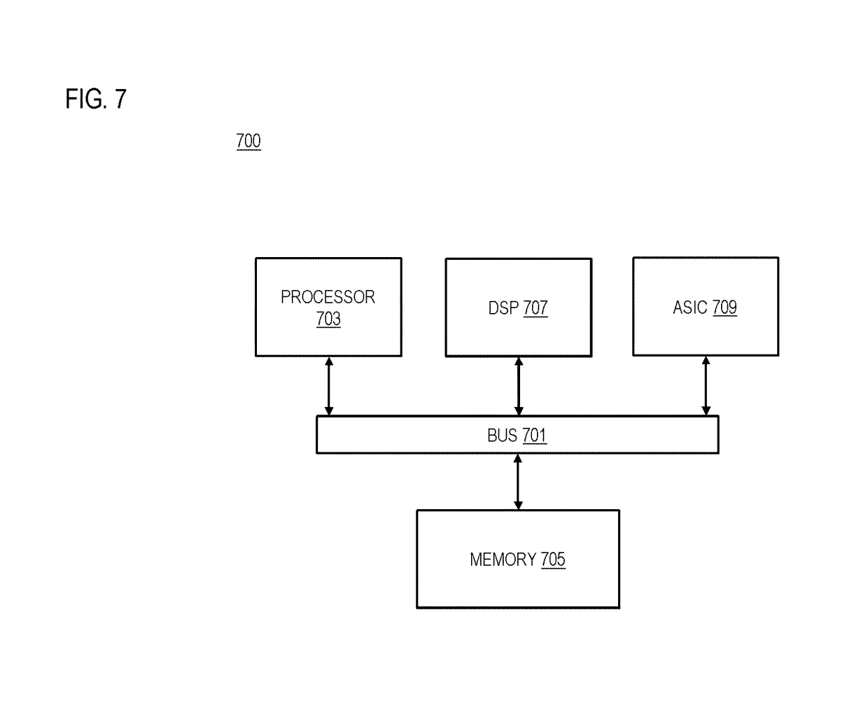

FIG. 3 is a flowchart of a process for determining a prompt for a challenge and presenting a challenge response input mechanism, according to one embodiment. In various embodiments, the runtime module 205 and/or the services platform 109 perform all or parts of the process 300 and are implemented in, for instance, a chip set including a processor and a memory as shown FIG. 7. In certain embodiments, the services platform 109 may perform some or all of the steps of the process 300 and communicate with the UE 101 using a client server interface. For example, the UE 101 may activate applications 103 for requesting and displaying a perspective display from the services platform 109. Moreover, the applications 103 may execute upon the runtime module 205.

At step 301, the applications 103 determines a prompt for a challenge on the UE 101. In various embodiments, the challenge may be for a CAPTCHA process, an authentication process and the like. For example, the challenge may comprise one or more distorted images of text characters, of objects, audio, video, etc., wherein the user has to identify, match, name, etc. the one or more images presented in the challenge. In another example, the challenge may be a prompt for the user to enter/submit one or more user information such as login name, account number, password and the like.

At step 303, the applications 103 and/or the challenge generator (e.g., the services platform 109, the authorization services 113, etc.) cause, at least in part, a rendering of an input mechanism for responding to the challenge, wherein the input mechanism presents, at least in part, one or more characters, one or more symbols, or a combination thereof for constructing a response to the challenge. For example, the challenge may include various distorted images (e.g., of text, pictures, etc.) where the user has to recognize each image and select/present a corresponding image via an input mechanism on the user device. In one example, the user may utilize one or more tumbler/combination dials to find and submit/present one or more characters corresponding to the one or more characters presented in the challenge. In another embodiment, a user utilizes an input mechanism to select and present one or more characters for a password, a login name, an account number and the like.

In various embodiments, the challenge, the input mechanism, the one or more characters, the one or more symbols, or a combination thereof are received from a remote service. For example, a user may request for a service from a service provider, wherein the service provider may require authorization/verification of the user before providing the requested service. Further, the service provider and/or an authorization/verification service may utilize one or more characters and/or one or more symbols to generate and present a challenge and an input mechanism to the user for the authorization/verification. In another embodiment, the input mechanism is a web object. For example the input mechanism is substantially generated by a service provider and presented as a web object (e.g., Java application) wherein the user device does not need to have a special application for rendering the input mechanism and can run in a web browser application. In another embodiment, the challenge, the one or more characters and/or the one or more symbols are received as at least one image. For example, an image comprises one or more altered/distorted characters (e.g., textual, geometric, etc.) and instructions (e.g., a challenge) for a user to identify and/or match the altered/distorted characters to another set of characters via an input mechanism.

In one embodiment, a language for the challenge, the one or more characters, the one or more symbols, or a combination thereof is selected (e.g., by a service provider) independently of another language that is associated with the device, a user of the device, or a combination thereof For example, a service provider may utilize one or more languages for generating a challenge wherein the languages may be different than one or more languages defined/selected by a user who will be receiving the one or more challenges. In one use case, an image in a challenge includes three distorted Latin characters (e.g., [symbol] , [symbol] , [symbol] ) wherein a combination dial comprises at least a portion of the Latin alphabet that includes the three Latin characters (e.g., K, D, O) presented in the challenge image.

In another embodiment, the input mechanism may be rendered based, at least in part, on one or more CAPTCHA parameters. For example, the CAPTCHA generator (e.g., a service provider, an authorization services, etc.) may provide information on the number of characters (e.g., five different Latin letters) present in a given challenge wherein the information may be utilized by one or more applications on the user device and/or a service provider to determine possible number of characters necessary to have on the input mechanism (e.g., 10, 15, 20, etc.) so that a user may be able to utilize the input mechanism for inputting a proper response. In another example, a CAPTCHA may comprise a combination of alphanumeric and geometrical characters wherein the input mechanism is determined such that it includes the alphanumeric and geometrical figures required for constructing a proper response. It is noted that the ability to render a virtual input mechanism based, at least in part, on a given CAPTCHA provides for a dynamic and flexible input mechanism such that it can comprise multiple possible combination of characters, letters, numbers, languages, figures and the like as utilized in generating a CAPTCHA.

At step 305, at least a portion of the at least one image is presented in the input mechanism. For example, (1) a challenge image has multiple characters therein (e.g., textual string), (2) a combination dial (e.g., with multiple dials) is presented as an input mechanism, and (3) at least one of the multiple characters is presented on the combination dial.

At step 307, the user and/or the UE 101 determines an input for selecting the at least a portion of the at least one image. For example, the user may select a character from a multiple of characters presented in a challenge image so that the user can determine and select a corresponding character on the input mechanism.

At step 309, one or more inputs are processed (e.g., by one or more applications on the user device) in order to determine an associated at least one of the one or more characters, the one or more symbols for constructing a response. In one use scenario, there are four distorted (e.g., blurred) alphabet characters in the challenge image wherein the user chooses the first character (e.g., by clicking on a character via the device UI) and then utilizes an input mechanism (e.g., a combination dial/virtual scroller on a touch screen) to select a corresponding character to the chosen character; thereafter, the user chooses a second character in the challenge image and proceeds to select a character on the input mechanism which corresponds to the second chosen character and thereby continues on to the third and fourth characters for constructing a complete response to the challenge.

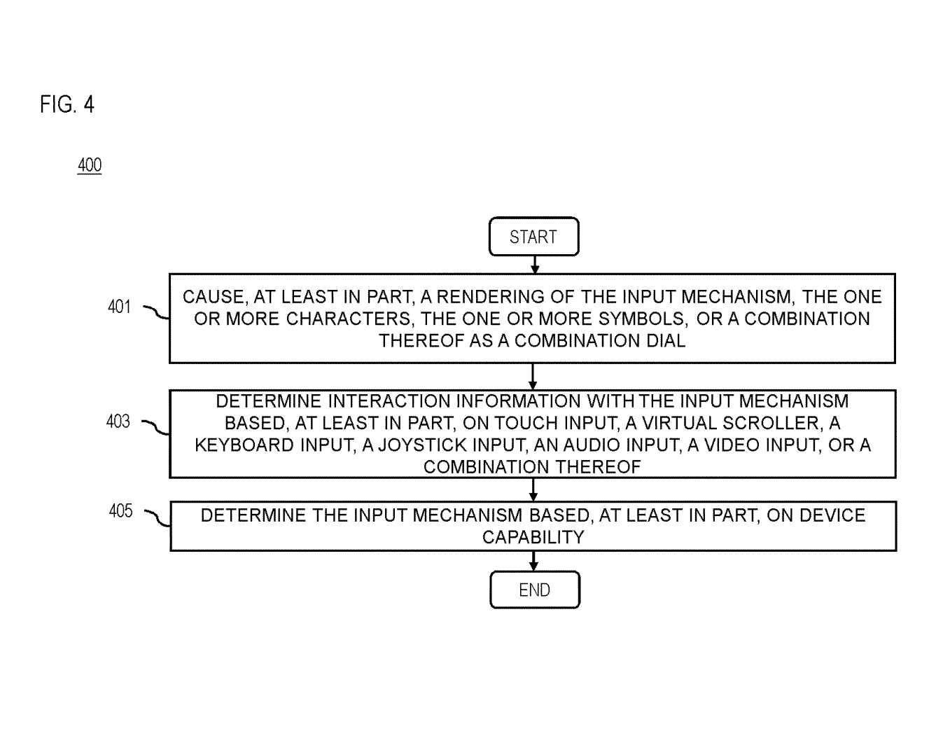

FIG. 4 is a flowchart of a process for presenting a challenge response input mechanism and one or more characters associated with a challenge, according to one embodiment. In various embodiments, the runtime module 205 and/or the services platform 109 perform all or parts of the process 400 and are implemented in, for instance, a chip set including a processor and a memory as shown FIG. 7. In certain embodiments, the services platform 109 may perform some or all of the steps of the process 400 and communicate with the UE 101 using a client server interface. For example, the UE 101 may activate applications 103 for requesting and displaying a perspective display from the services platform 109. Moreover, the applications 103 may execute upon the runtime module 205.

At step 401, an input mechanism, the one or more characters, the one or more symbols, or a combination thereof are presented in a form of one or more combination dials. For example, a CAPTCHA challenge may include an image comprising multiple characters (e.g., geometrical shapes) which may be distorted and/or blurred. Further, one or more tumbler/combination dials are presented to the user whereby the user can select characters (e.g., via a touch screen, via a virtual scroller, via a keypad, via a joystick, etc.) on the tumbler/combination dials corresponding to the characters presented in the challenge.

At step 403, applications 103 determine interaction information with the input mechanism based, at least in part, on touch input, a keyboard input, a virtual scroller, a joystick input, an audio input, a video input, or a combination thereof For example, the capability information may indicate that the user device has certain user interface/input capabilities such as a physical keypad, a virtual scroller, a joystick, a color display, touch sensitive display, certain size of a display, a certain type of keypad, an audio input, a video input and the like. In an example, user device capability information indicates availability of a touch sensitive display whereby a combination dial can be presented to the user and which can be utilized by the user to construct a response to a challenge. In another example, a user device may utilize a keypad (e.g., physical or virtual) to interface with the one or more combination dials to select one or more characters (e.g., figures) for constructing and/or submitting a response to a challenge.

At step 405, services platform 109 and/or applications 103 determine the input mechanism based, at least in part, on device capability. For example, a service provider may request, receive and utilize the device capability information when generating and/or presenting a challenge at the user device. In another embodiment, the applications 103 can determine the input mechanism based on a current state of the user device. For example, a user device capability information may indicate that the user device is capable of presenting a virtual keypad on a touch sensitive UI display; however, in an example when the touch sensitive UI display is malfunctioning, the applications 103 can determine and utilize a different available input mechanism on the UE 101, for example, an available physical keypad or a joystick.

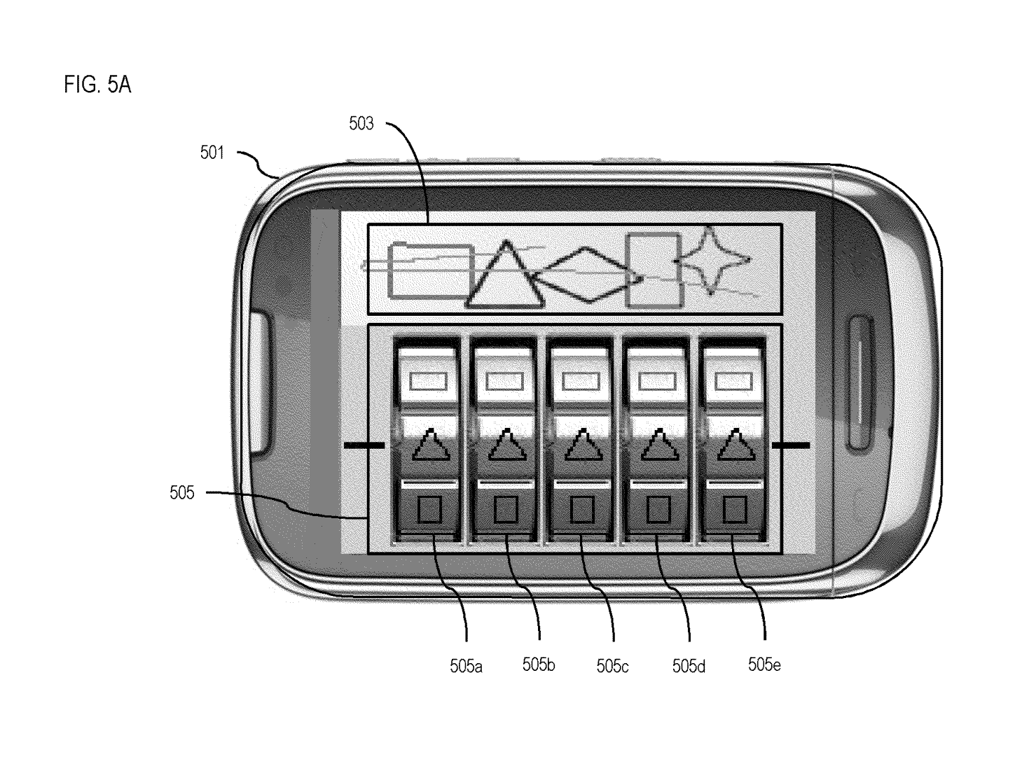

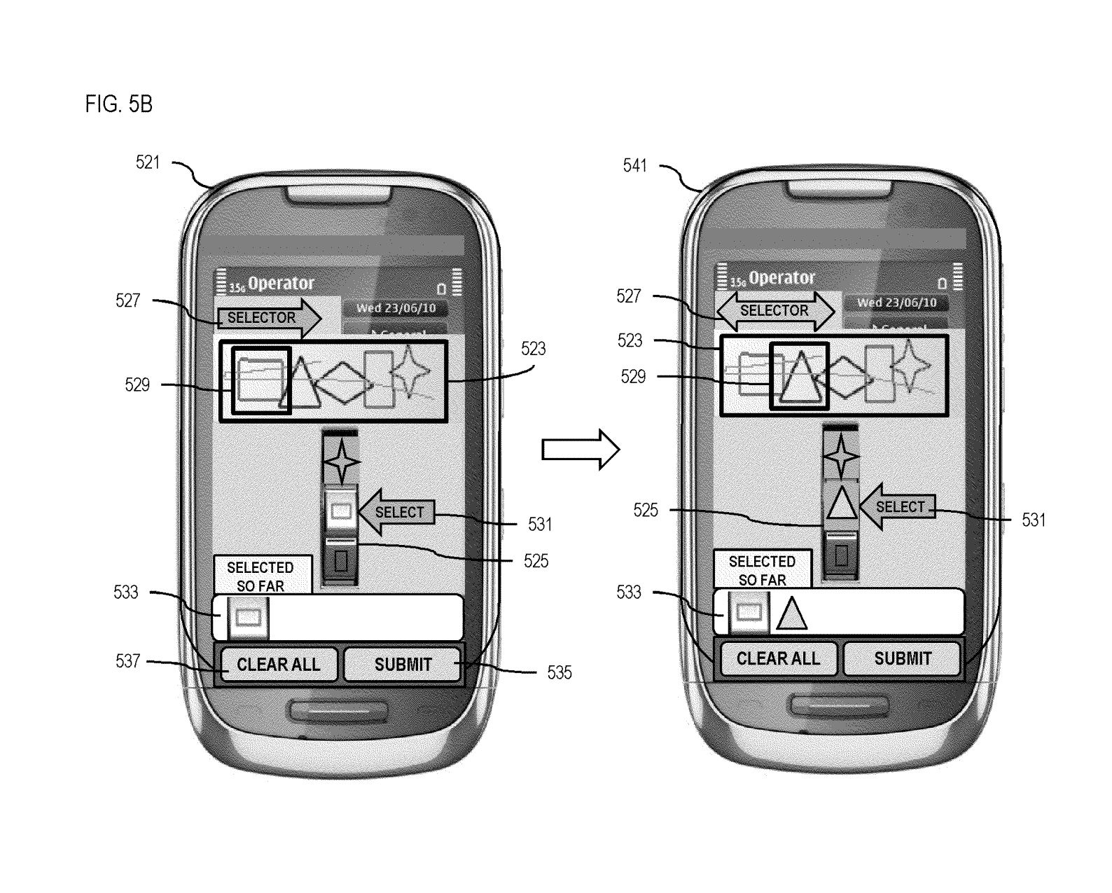

FIGS. 5A and 5B are diagrams of various user interfaces depicting challenges and input mechanisms, according to various embodiments. FIG. 5A shows UI 501 wherein a challenge 503 by a service provider, comprising five distorted geometric figures (e.g., a distortion line drawn through the figures), is presented to the user of UE 101. Further, an input mechanism 505, comprising a combination dial with five sliders/dials 505a-505e, is also presented to the user wherein each slider/dial corresponds to one of the figures of the challenge 503 such that the user can set each of the sliders/dials to match its corresponding figure in the challenge 503 for constructing a response to the challenge. In various embodiments, the challenge 503 may comprise various figures, alphanumeric characters, symbols or a combination thereof

FIG. 5B shows UIs 521 and 541 depicting a challenge and an input mechanism. In the UI 521 a challenge 523 includes five distorted geometric figures, an input mechanism comprising a combination dial/slider 525, a challenge selector 527, a current challenge selection indicator 529, an input selector 531 for the input mechanism, a current response selection indicator area 533, function key 535 for “SUBMIT” and function key 537 for “CLEAR ALL.” In various embodiments, the input mechanism may include one or more combination dials/sliders such that the number of dials/sliders 525 may be more than, less than or the same as the number of characters presented in a challenge 523. In one use scenario, the user selects a figure from those presented in the challenge 523 by utilizing the selector 527 (e.g., click left, right, up, down, etc.) which in turn may cause the current challenge selection indicator 529 (e.g., a selection box, a highlighter, etc.) to move (e.g., left, right, up, down, etc.) to next character/figure in the challenge 523. Next, the user selects a corresponding figure on the combination dial/slider 525 by utilizing the input selector 531 which causes the selected input (e.g., a square figure) to appear in the current response selection indicator area 533 at the same position as the selection indicator 529 was when the selection was made (e.g., a selection for the first character in the challenge will appear in the first position of the current response selection indicator area 533.) In the UI 521 example, the first rectangular figure in the 523 list is shown as selected by the current challenge selection indicator 529 and a corresponding rectangular shape on the combination dial 525 is selected via the input selector 531 and a representation of the first rectangular figure is shown in the current response selection indicator area 533. Further, in the UI 541 the user utilizes the selector 527 to select the second figure (e.g., a triangle) presented in the challenge 523 which causes the current challenge selection indicator 529 to move (e.g., right) to next character/figure in the challenge 523. Furthermore, a selection of a triangle on the combination dial 525 is made and a corresponding triangular shape is shown in the current response selection indicator area 533. The process may continue as such until the user decides to submit (e.g., after selecting five figures) a response to the service provider by utilizing the “SUBMIT” function key 535. Moreover, the user may utilize the “CLEAR ALL” function key to clear all selections and possibly start over. In one embodiment, clearing all selections may cause a service provider to present a different challenge to the user. In another embodiment, the challenge selector 527 may be utilized to go back/reverse to a previous position in the challenge 523 whereby that reversal may also clear a currently made selection from the “current response selection indicator area” 533 if a selection for the current position has already been made. In one use scenario in UI 541, (1) there are five characters in the challenge 523 and, (2) a user selects three input characters via 525 and 531 for a response and, (3) there are now three characters shown in a response area 533 (e.g., as partial response so far), (4) the user wishes to change the last response and reverses back to position number two in the response 523 via challenge selector 527 wherein this reversal action causes removal of the third selected input character from the response area 533. At this point, there are two selected characters in the response area 533 (e.g., partial response) and the current challenge selection indicator 529 is on the second character of the challenge 523 wherein the user may proceed to move the current challenge selection indicator 529 to the third character of the challenge 523 and reselect an input.

The processes described herein for presenting a challenge response input mechanism on a device may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

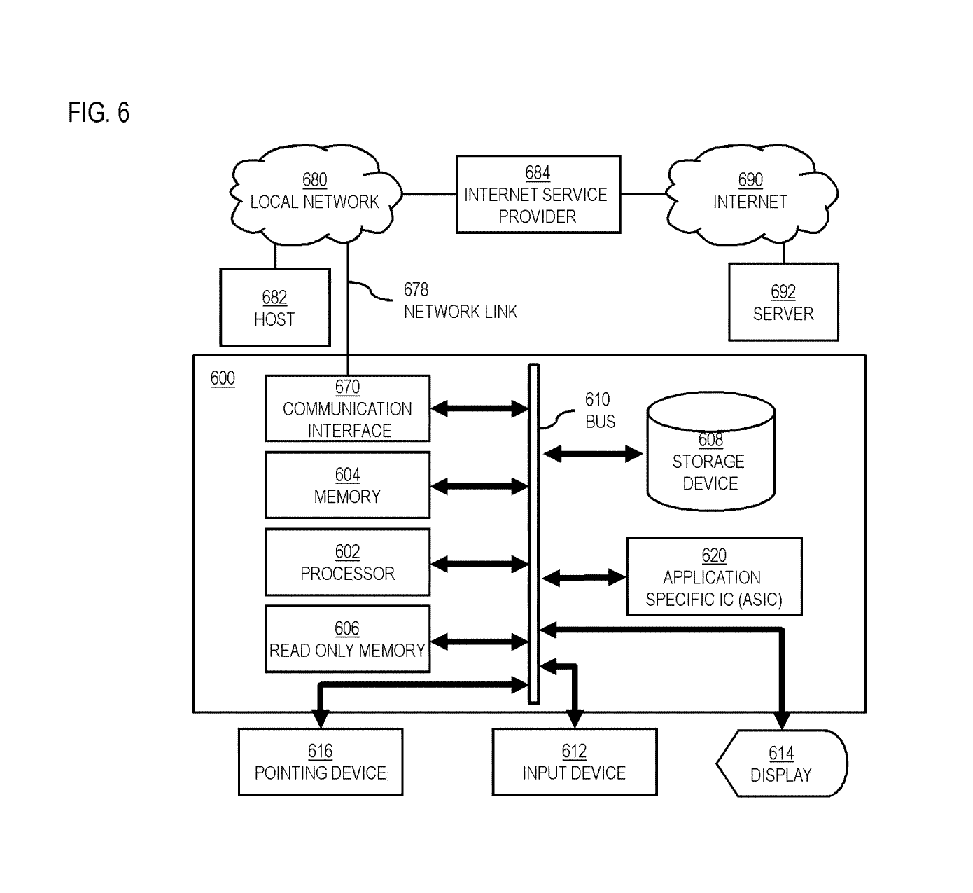

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to present a challenge response input mechanism on a device as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of presenting a challenge response input mechanism on a device. A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to presenting a challenge response input mechanism on a device. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for presenting a challenge response input mechanism. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for presenting a challenge response input mechanism on a device is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 107 for presenting a challenge response input mechanism.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to present a challenge response input mechanism on a device as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of presenting a challenge response input mechanism on a device.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to present a challenge response input mechanism on a device. The memory 705 also stores the data associated with or generated by the execution of the inventive steps.

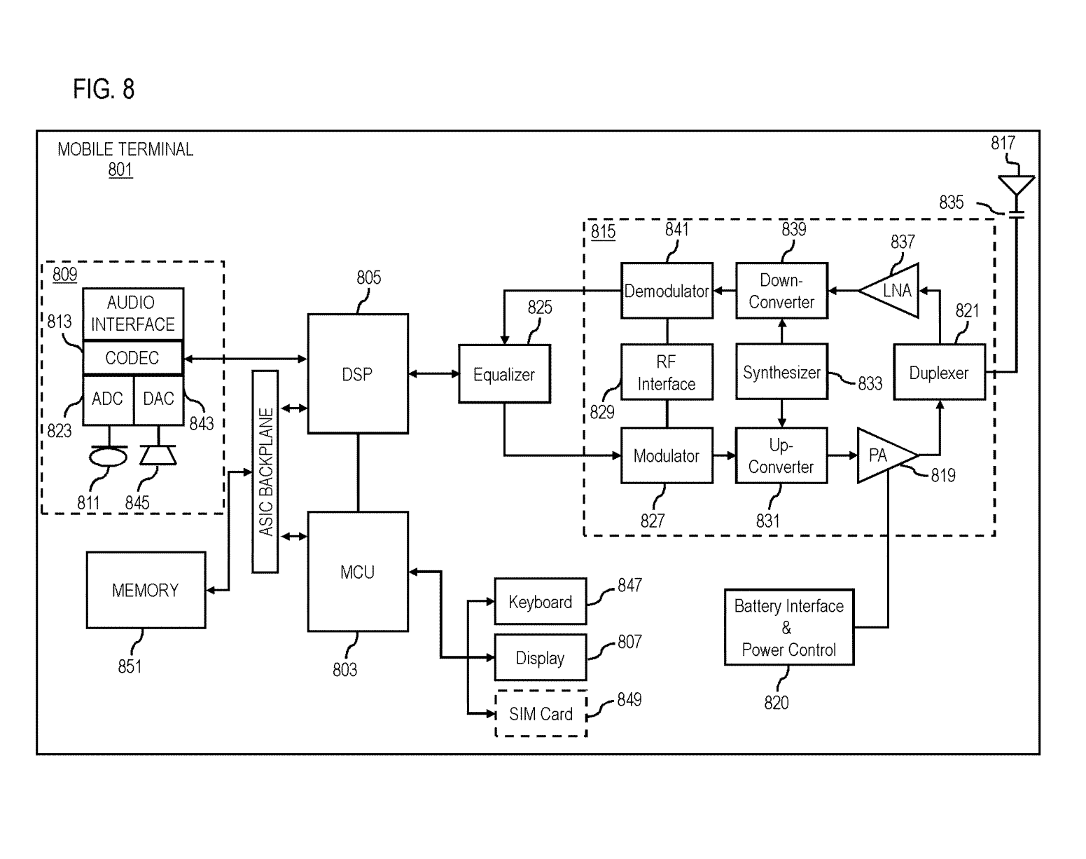

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for presenting a challenge response input mechanism on a device. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or theft) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of presenting a challenge response input mechanism on a device. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to present a challenge response input mechanism on a device. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a determination of a prompt for a challenge on a device; and
a rendering of an input mechanism for responding to the challenge,
wherein the input mechanism presents, at least in part, one or more characters, one or more symbols, or a combination thereof for constructing a response to the challenge.

2. A method of 1, wherein the challenge, the input mechanism, the one or more characters, the one or more symbols, or a combination thereof are received from a remote service.

3. A method of claim 2, wherein the challenge, the one or more characters, the one or more symbols, or combination thereof are received as at least one image.

4. A method of claim 3, wherein the (1) data and/or (2) information and/or (3) at least one signal are further based, at least in part, on the following:
a presentation of at least a portion of the at least one image in the input mechanism;
a determination of an input for selecting the at least a portion of the at least one image; and
processing and/or facilitating a processing of the input to determine an associated at least one of the one or more characters, the one or more symbols for constructing the response.

5. A method of claim 1, wherein the challenge is for a CAPTCHA process, an authentication process, or a combination thereof

6. A method of claim 1, wherein the (1) data and/or (2) information and/or (3) at least one signal are further based, at least in part, on the following:
a rendering of the input mechanism, the one or more characters, the one or more symbols, or a combination thereof as a combination dial.

7. A method of claim 1, wherein the (1) data and/or (2) information and/or (3) at least one signal are further based, at least in part, on the following:
a determination of interaction information with the input mechanism based, at least in part, on touch input, a keyboard input, a virtual scroller, a joystick input, an audio input, a video input, or a combination thereof

8. A method of claim 1, wherein the (1) data and/or (2) information and/or (3) at least one signal are further based, at least in part, on the following:
a determination of the input mechanism based, at least in part, on device capability.

9. A method of claim 1, wherein a language for the challenge, the one or more characters, the one or more symbols, or a combination thereof is selected independently of another language that is associated with the device, a user of the device, or a combination thereof

10. A method of claim 1, wherein the input mechanism is a web object.

11. An apparatus comprising:
at least one processor; and
at least one memory including computer program code for one or more programs, the at least one memory and the computer program code configured to, with the at least one processor, cause the apparatus to perform at least the following, determine a prompt for a challenge on a device; and
cause, at least in part, a rendering of an input mechanism for responding to the challenge,
wherein the input mechanism presents, at least in part, one or more characters, one or more symbols, or a combination thereof for constructing a response to the challenge.

12. An apparatus of 11, wherein the challenge, the input mechanism, the one or more characters, the one or more symbols, or a combination thereof are received from a remote service.

13. An apparatus of claim 12, wherein the challenge, the one or more characters, the one or more symbols, or combination thereof are received as at least one image.

14. An apparatus of claim 13, wherein the apparatus is further caused to:
cause, at least in part, a presentation of at least a portion of the at least one image in the input mechanism;
determine an input for selecting the at least a portion of the at least one image; and
process and/or facilitate a processing of the input to determine an associated at least one of the one or more characters, the one or more symbols for constructing the response.

15. An apparatus of claim 11, wherein the challenge is for a CAPTCHA process, an authentication process, or a combination thereof

16. An apparatus of claim 11, wherein the apparatus is further caused to:
cause, at least in part, a rendering of the input mechanism, the one or more characters, the one or more symbols, or a combination thereof as a combination dial.

17. An apparatus of claim 11, wherein the apparatus is further caused to:
determine interaction information with the input mechanism based, at least in part, on touch input, a keyboard input, a virtual scroller, a joystick input, an audio input, a video input, or a combination thereof

18. An apparatus of claim 11, wherein the apparatus is further caused to:
determine the input mechanism based, at least in part, on device capability.

19. An apparatus of claim 11, wherein a language for the challenge, the one or more characters, the one or more symbols, or a combination thereof is selected independently of another language that is associated with the device, a user of the device, or a combination thereof

20. An apparatus of claim 11, wherein the input mechanism is a web object.

21.-48. (canceled)
